(19) United States
(12) Patent Application Publication
(10) Pub. No.: US 2014/0236611 A1
(43) Pub. Date: Aug. 21, 2014

(54) PROXIMITY TRACKING SYSTEMS AND METHOD

(71) Applicant: Hill-Rom Services, Inc ., Batesville, IN (US)

(72) Inventors: David L. Ribble, Indianapolis, IN (US); Steven A. Dixon, Riverview, FL (US)

(73) Assignee: Hill-Rom Services, Inc., Batesville, IN (US)

(21) Appl. No.: 14/179,782

(22) Filed: Feb. 13, 2014

Related U.S. Application Data
(60) Provisional application No. 61/765,923, filed on Feb. 18, 2013.

(51) Int. Cl. G06F 19/00

(52) U.S. Cl. CPC G06F 19/327
USPC 705/2; 340/539.13

(57) ABSTRACT

Systems and methods to track proximity of articles, locations and people are disclosed herein. Radio frequency tags are configured to communicate proximity of articles, locations and people over time.

### CROSS REFERENCE TO RELATED APPLICATIONS

The present application claims the benefit, under 35 U.S.C. §119(e), of U.S. Provisional Application No. 61/765,923, which was filed Feb. 18, 2013, and which is hereby incorporated by reference herein in its entirety.

### BACKGROUND

Tracking spread of contagion is an ongoing challenge, particularly in a healthcare environment. Early detection of contagion and identification of people and/or objects that have come in direct or indirect contact with other people and/or objects is desirable for mitigation of spread of contagion. While several system and methods exist for contact tracking a need exists for development in this area.

### BRIEF SUMMARY

The present disclosure includes one or more of the features recited in the appended claims and/or the following features which, alone or in any combination, may comprise patentable subject matter.

One embodiment of a system for proximity tracking may comprise a patient radio frequency tag comprising a memory and a caregiver radio frequency tag configured to communicate with said patient radio frequency tag when said caregiver radio frequency tag and said patient radio frequency tag are within a predetermined spatial distance from each other, the memory of the patient radio frequency tag is configured to store information indicative of communication with the caregiver radio frequency tag.

One embodiment of a system for tracking contagion may comprise multiple radio frequency tags configured to identify at least one of people, location and object. At least one processing hub may be configured to track proximity between the multiple radio frequency tags, the at least one processing hub may be configured to identify potential contact amongst entities assigned said multiple radio frequency tags thereby identifying potential spread of contagion.

One embodiment of a system may comprise means to track spread of contagion based on proximity of multiple radio frequency tags with respect to each other.

Another embodiment of a system may comprise means to determine adherence to a protocol based on proximity of multiple radio frequency tags with respect to each other.

One embodiment of a system may comprise means to determine physical activity of a person based on proximity of multiple radio frequency tags with respect to each other.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF DRAWINGS

The accompanying drawings incorporated in and forming a part of the specification illustrate several aspects of the claimed subject matter and, together with the description, serve to explain the principles of the claimed subject matter. In the drawings:

FIG. 1 shows garments for use with proximity tracking systems, constructed according to one or more of the principles disclosed herein;

FIG. 2 shows one embodiment of radio frequency tags used in proximity tracking systems, constructed according to one or more of the principles disclosed herein;

FIG. 3 shows a block diagram of one embodiment of a passive radio frequency tag configured to communicate with other radio frequency tags, constructed according to one or more of the principles disclosed herein;

FIG. 4 shows a block diagram of a processing hub configured to communicate with one or more radio frequency tags, constructed according to one or more of the principles disclosed herein;

FIG. 5 shows one embodiment of display of tracking information, constructed according to one or more of the principles disclosed herein;

FIG. 6 shows another embodiment of display of tracking information, constructed according to one or more of the principles disclosed herein;

FIG. 7 is a representation of one embodiment of display of tracking information, constructed according to one or more of the principles disclosed herein; and

FIG. 8 is another representation of an embodiment of display of tracking information, constructed according to one or more of the principles disclosed herein.

### DETAILED DESCRIPTION OF ILLUSTRATIVE EMBODIMENTS

The embodiments of the claimed subject matter and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be briefly mentioned or omitted so as to not unnecessarily obscure the embodiments of the claimed subject matter described. The examples used herein are intended merely to facilitate an understanding of ways in which the claimed subject matter may be practiced and to further enable those of skill in the art to practice the embodiments of the claimed subject matter described herein. Accordingly, the examples and embodiments herein are merely illustrative and should not be construed as limiting the scope of the claimed subject matter, which is defined solely by the appended claims and applicable law. Moreover, it is noted that like reference numerals represent similar parts throughout the several views of the drawings.

It is understood that the subject matter claimed is not limited to the particular methodology, protocols, devices, apparatus, materials, applications, etc., described herein, as these may vary. It is also to be understood that the terminology used herein is used for the purpose of describing particular embodiments only, and is not intended to limit the scope of the claimed subject matter.

Unless defined otherwise, all technical and scientific terms used herein have the same meanings as commonly understood by one of ordinary skill in the art.

The subject matter disclosed herein is generally related to tracking proximity of people and/or objects relative to other locations and/or people and/or objects in a healthcare setting.

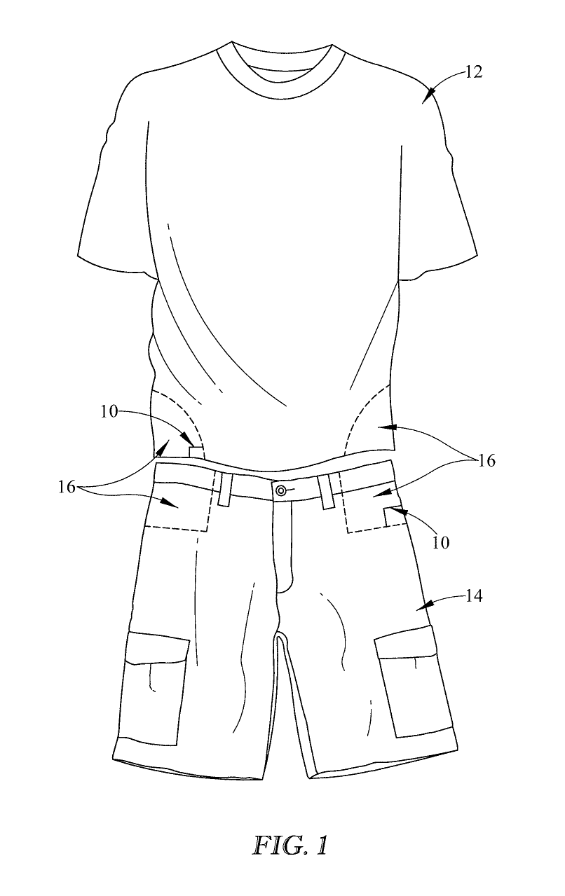

Garments for use in one embodiment of a system for proximity tracking are shown in FIG. 1. In the embodiment shown in FIG. 1, an upper garment 12 and lower garment 14 comprise pockets 16. Radio Frequency (RF) tags 10 are placed inside at least one of the pockets 16 in the embodiment shown. In other embodiments one or multiple RF tags 10 may be placed on any portion of the garment or accessory including but not limited to belts, wallets and necklaces. The RF tags 10 are sewn into garments or an accessory in other embodiments. In the embodiment shown in FIG. 1, the RF tags 10 are retained inside the pockets 16 by hooked fastening systems such as VELCRO® systems, while in other embodiments, the RF tags may be retained in pocket 16 by any other mechanisms including but not limited to buttoned connections, strapped connection, buckled connection and adhesives.

The radio frequency systems used in the various systems and methods described herein may be of any configuration, including but not limited to, Passive Reader Active Tag (PRAT) system, Active Reader Passive Tag (ARPT) system and Active Reader Active Tag (ARAT) system.

RF tags 10 used in the systems and methods described herein may be of any type including but not limited to passive, active or battery assisted passive. Although a few embodiments of RF tags 10 are described in this disclosure, any type of RF tag 10 may be used, including but not limited to, read-only, having a factory assigned serial number used as a key in a database, read/write. In another embodiment object specific data may be written on the RF Tag 10. Programmable RF tag 10 may be write-once, read-multiple and blank tags may be written upon with an electronic product code by the user in various embodiments.

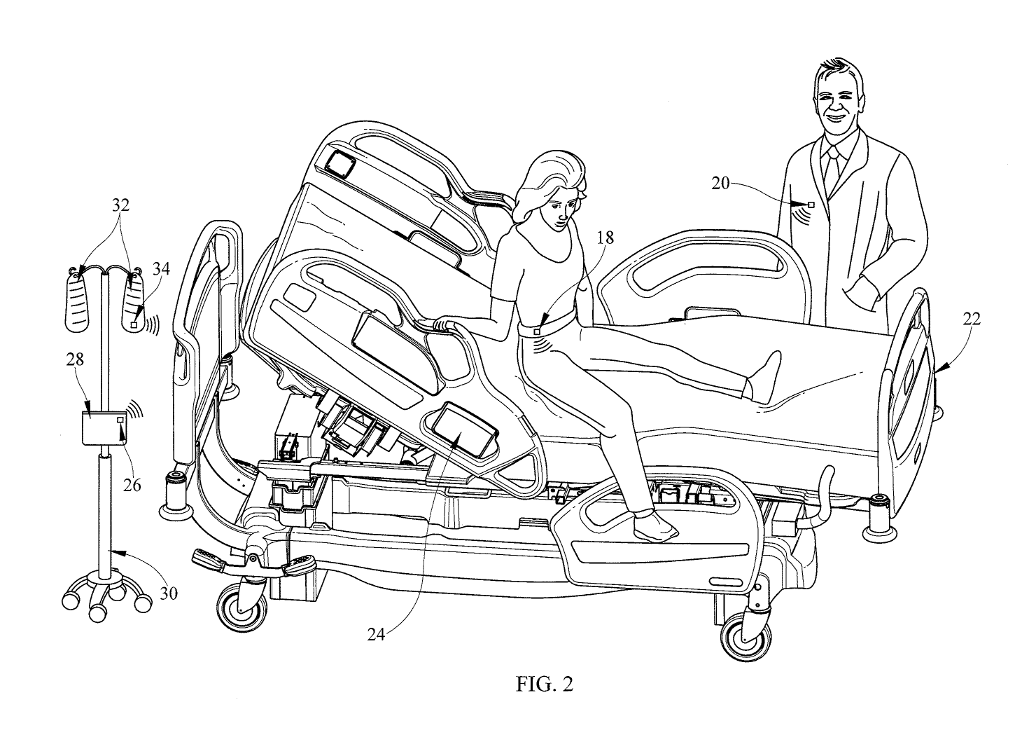

FIG. 2 shows one embodiment of a system for tracking proximity. In the embodiment shown in FIG. 2, a patient RF tag 18 is configured to communicate with a caregiver RF tag 20, infusion pump RF tag 26 mounted on an infusion pump 28, drip bag RF tag 34 mounted on a drip bag 32, and a user interface 24 of a person support apparatus 22. In the embodiment shown in FIG. 2, the system for tracking proximity comprises radio frequency based communication between RF tags assigned to people (such as caregivers and patients), locations (hospital room identifier RF Tag), and objects (such as infusion pumps and drip bags). In one embodiment, pre-determined zones of spatial proximity are identified for a selected RF tag and RF tags identifying people, locations and/or objects within each predetermined zone of spatial proximity of selected RF tag are logged. In the embodiment shown in FIG. 2, the patient RF tag 18 is configured to log proximity of the various RF tags within predetermined spatial ranges from the patient RF tag 18. In one embodiment, a predetermined spatial zone of proximity is defined as a contact zone and potential physical contact between the objects and/or people identified by the respective RF Tags is summarized when one RF tag is detected within the contact zone of another RF tag. In one exemplary embodiment, the contact zone is defined as a radius of 0.25 inch from one RF tag requiring physical contact with other RF tags. In another exemplary embodiment the contact zone is defined as a sphere of radius of 24 inches from a RF tag wherein other entities (persons and/or objects) within the contact zone may be in a position to establish physical contact, despite the RF tags not touching. In other embodiments, the spatial zones of proximity may be programmable allowing a user to vary the spatial zone(s) of interest and/or vary the spatial definition of the contact zone. Multiple zones in addition to the contact zone may be defined in other embodiments based on spatial proximity. Any system for determining proximity and/or pre-determined zones of proximity may be employed in other embodiments. In one embodiment, signal strength between RF tags is used as an indication of spatial proximity of one RF tag relative to another RF tag.

Embodiments of person support systems are found in patents U.S. Pat. No. 7,296,312, U.S. Pat. No. 6,047,424, U.S. Pat. No. 7,176,391, U.S. Pat. No. 7,335,839, U.S. Pat. No. 7,437,787, and U.S. Pat. No. 7,253,366 and patent application publications US2007/0266499 and US2010/0122415 all of which are hereby incorporated by reference herein.

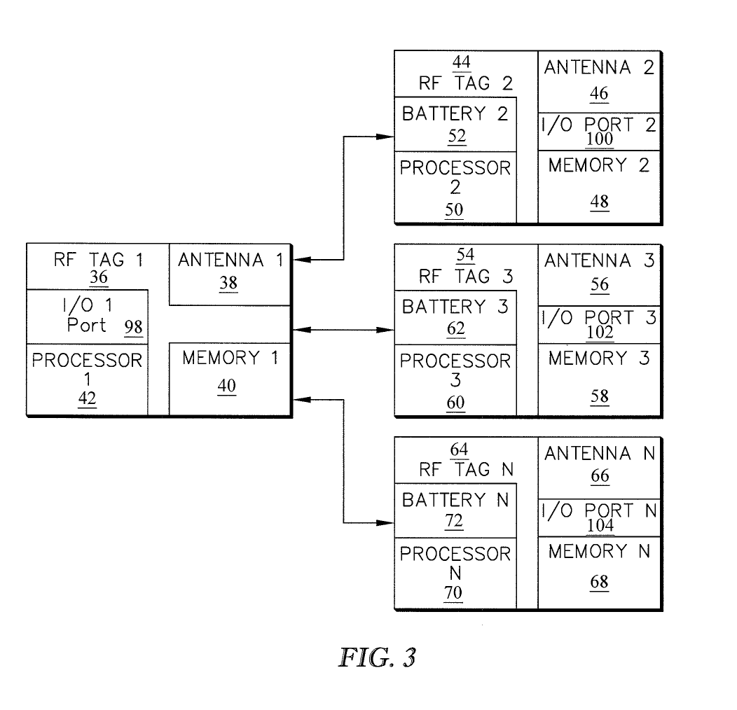

FIG. 3 shows one embodiment of a proximity sensing system with a non-powered RF Tag 1 36 configured to communicate with multiple other RF tags in one embodiment. FIG. 3 shows a Passive Reader Active Tag (PRAT) system wherein RF Tag 1 is configured to receive radio signals from battery powered active tags RF Tag 2 44, RF Tag 3 54 and RF Tag N 64 by way of antenna 1 38. In the embodiment shown in FIG. 2, RF Tag 1 comprises processor 1 42, memory 1 40 and I/O Port 1 98. RF Tag 1 is configured to store signals received from other RF Tags in memory 1 40. Processor 1 42 is configured to process signals received from other RF Tags in this embodiment to determine proximity of other RF tags based on signal strength and store information relating to proximity of other RF Tags in memory 1 40. I/O Port 1 98 allows reading of and writing to the memory 1 40. In one embodiment, the I/O Part 1 98 allows for proximity information of other RF Tags stored in memory 1 40 to be accessed. In another embodiment, the I/O Port 1 98 is configured to allow access to raw signals received from other RF Tags which are then processed remotely to determine proximity of other RF Tags from RF Tag 1. In the embodiment shown, RF Tag 2 44 comprises an antenna 2 46, battery 2 52, processor 2 50, memory 2 48 and I/O Port 2 100. RF Tag 3 54 comprises antenna 3 56, battery 3 62, processor 3 60, memory 3 58 and I/O Port 2 102. RF Tag N 64 comprises antenna N 66, I/O Port N 104, memory N 68, processor N 70 and battery N 72. In other embodiments, any of the RF Tags shown in FIG. 3 may be powered or non-powered. In other embodiments, RF Tag 1 comprises a battery and the system shown in FIG. 3 may be an Active Reader Passive Tag (ARPT) system, Active Reader Active Tag (ARAT) system or Battery Assisted Passive (BAP) system.

The proximity sensing system shown in FIG. 3 shows a Passive Reader Active Tag (PRAT) system. In one embodiment RF Tag 1 36 is the patient RF tag 18 and is configured to store information related to proximity of other RF Tags shown in FIG. 2. In other embodiments, RF Tag 1 36 is a caregiver RF Tag 20 and proximity of other RF Tags are monitored in relationship to the caregiver. In one embodiment, hand washing activity and protocol adherence activity can be monitored by monitoring contact and/or proximity to a faucet and/or hand sanitizer with RF Tags. In another embodiment, proximity of a device over time to other devices and/or persons may be tracked.

In various embodiments disclosed herein, memory devices are disclosed. Any type of memory device, including but not limited to, volatile and non-volatile memory may be used. Processors disclosed herein may include, but are not limited to, microprocessors. Antennas disclosed herein are capable of sending and/or receiving radio frequency signals. I/O Ports disclosed herein may include, but are not limited to, Serial connections, Universal Serial Bus (USB) connections and Ethernet connections.

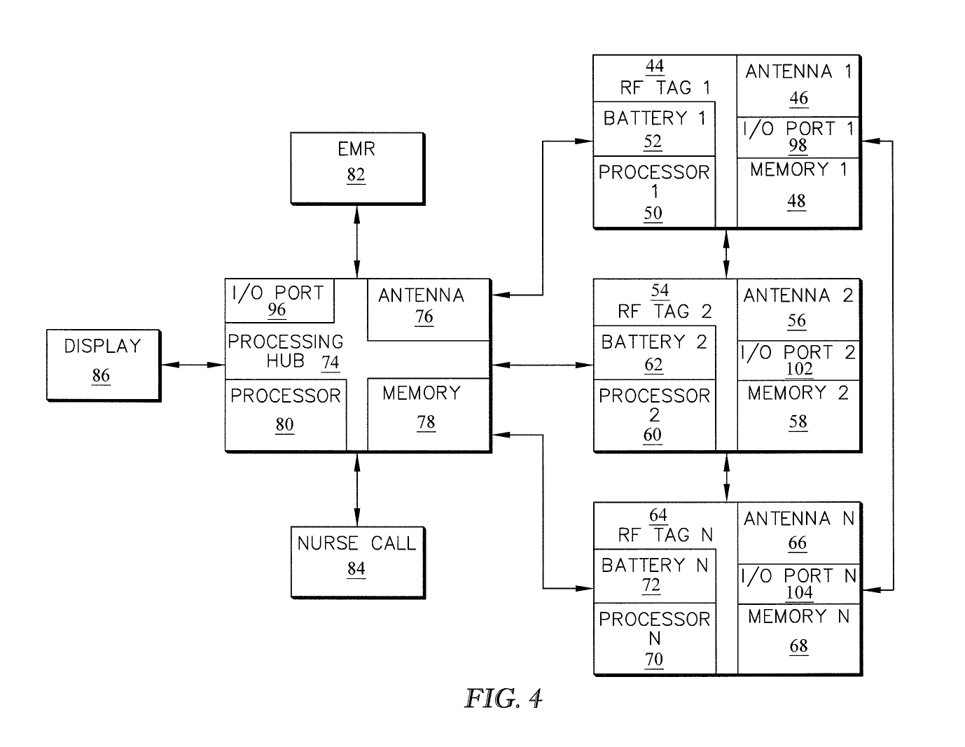

FIG. 4 shows one embodiment of a system to monitor proximity wherein one or more RF Tags are configured to communicate with a processing hub 74. In the embodiment disclosed in FIG. 4, processing hub 74 is a computing device. In various embodiments, processing hub 74 may be any type of computing device, including but not limited to, a personal computer, cellular phone, Personal Digital Assistant (PDA) and/or a server (cloud based or otherwise). In the embodiment shown in FIG. 4, multiple powered RF Tags are configured to communicate with each other as well as with the processing hub 74. In one embodiment, processing hub 74 is capable of monitoring the location of RF Tags spatially and therefore is able to monitor the proximity of RF Tags relative to other RF Tags. In this embodiment, when one RF Tag is within a pre-determined spatial zone of another RF Tag, the processing hub 74 logs the event in memory 78 and/or memory devices of one or more of the aforementioned RF Tags. In the embodiment shown in FIG. 4, the processing hub 74 comprises antenna 76, memory 78, processor 80 and I/O Port 96. The processing hub 74 is configured to communicate with a display 86 in this embodiment, an electronic medical record database (EMR) 82, and a nurse call system 84 in this embodiment. The display 86 in this embodiment is a computer monitor. In another embodiment the display 86 may be a portion of the user interface 24 of the person support apparatus 22.

In another embodiment, the processing hub 74 is a cellular phone and a passive RF Tag is configured to communicate information for its memory via communication with the cellular phone to other RF Tags and/or processors.

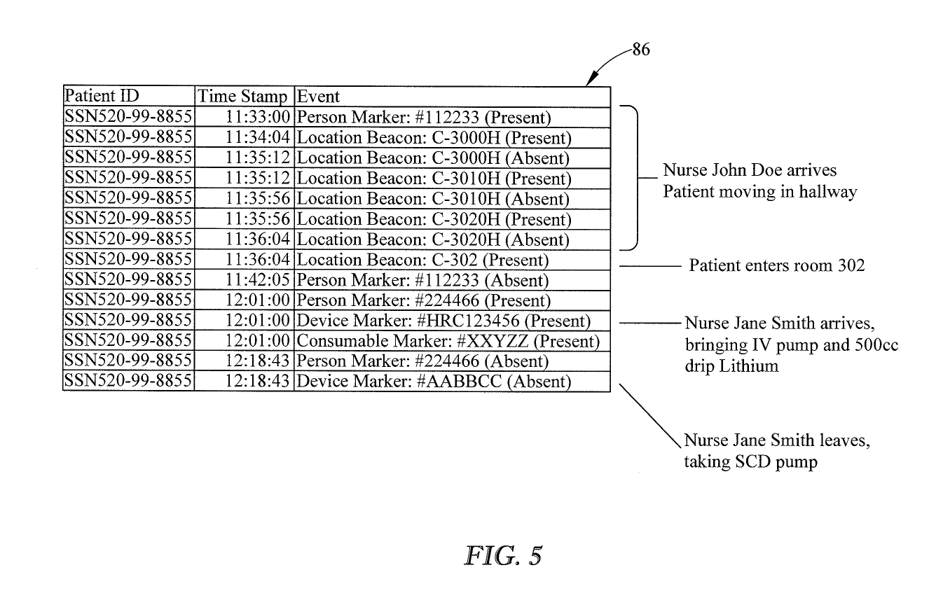

FIG. 5 shows one exemplary embodiment of display of tracking information. In the embodiment shown, display 86 lists the persons, locations and devices identified by their respective RF Tags that have been detected in the predetermined spatial zone of a patient RF Tag 18 with a time stamp of the event. In the exemplary embodiment shown in FIG. 5, row 2 indicates entry of a person with RF Tag marker #112233 within the predetermined spatial zone of the patient. As shown in FIG. 5, motion and subsequent lack of motion is detected in this embodiment by presence and absence of RF Tags identifying spatial locations from rows 3-9 in the patient's predetermined spatial zone. Row 10 indicates that person identified by RF Tag marker #112233 has left the predetermined zone of the patient RF Tag 18. Row 11 indicates that an RF Tag marker #224466 identifying a person has entered the predetermined zone of the patient RF Tag 18. Rows 12 -15 indicate presence and absence of devices and consumable(s).

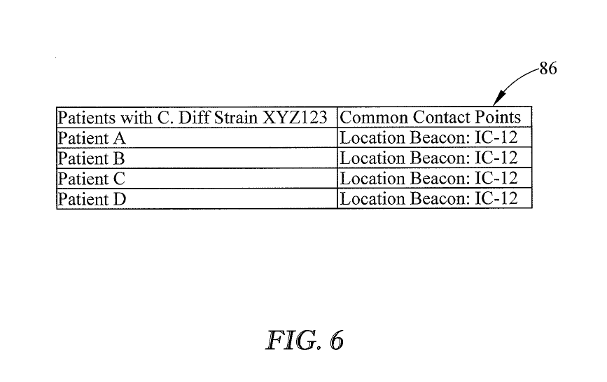

FIG. 6 shows another exemplary embodiment of display of tracking information. As shown in FIG. 6, patients with a commonality such as a disease are displayed. As shown in FIG. 6, common contact locations, people and/or objects may be identified based on the proximity tracking information obtained by the proximity tracking systems disclosed herein. Display of proximity tracking information shown in FIG. 6 may be used to identify potential source of infections and/or spread of contagion.

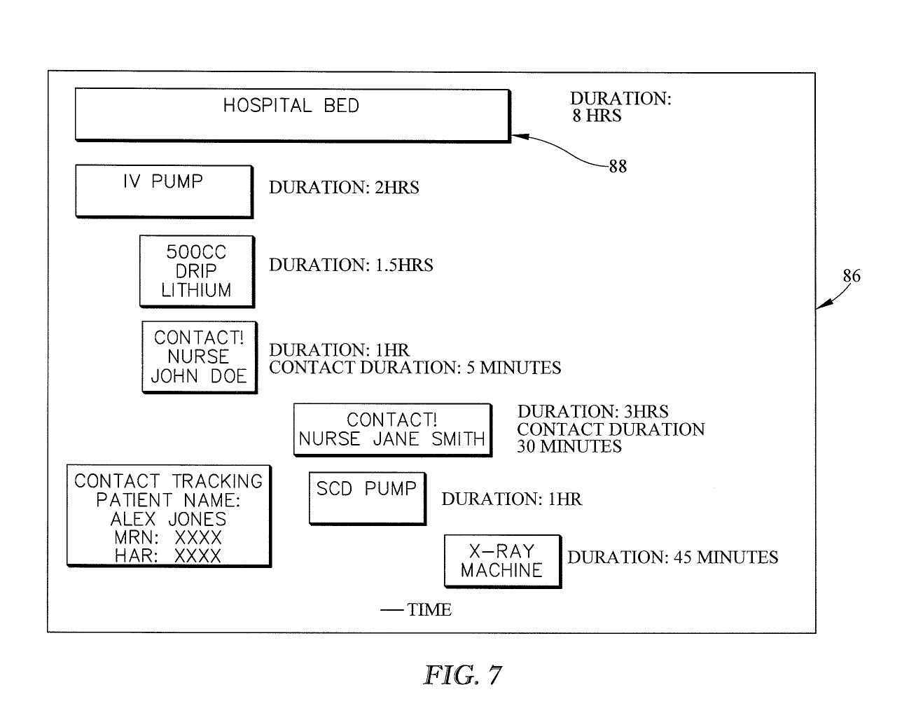

FIG. 7 shows one exemplary embodiment of display of tracking information. In the embodiment shown in FIG. 7, bar indicators 88 displayed on a display 86 convey information about objects, locations and/or people within a predetermined spatial range of an RF tag over a period of time. In the embodiment shown in FIG. 7, proximity of other RF Tags representing objects, people and locations over time is tracked along the horizontal axis. The length of the bar indicators 88 are proportional to the length of time in within a predetermined spatial zone of a RF tag of interest. In the embodiment shown in FIG. 7, the duration of time spent within a predetermined spatial proximity zone is also listed in addition to the visual bar indication. FIG. 7 shows the duration of time spent by objects and/or people in a contact zone in addition to total time spent in a predetermined zone of proximity. In the embodiment shown, if any duration of time of objects and/or people in the contact zone is detected the respective bar indicator 88 includes a textual message indicating potential contact. In other embodiments, the respective bar indicator may change color and/or an audio alarm may sound upon detection of contact.

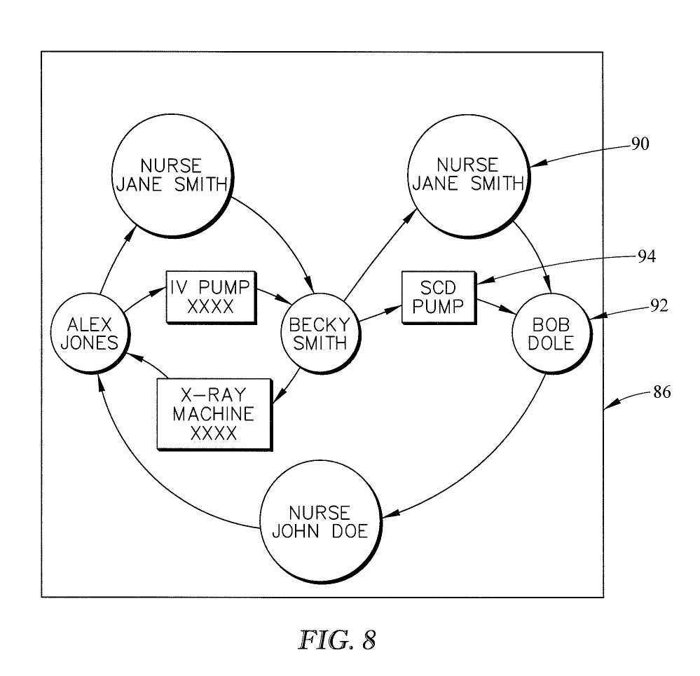

FIG. 8 shows another representation of an embodiment of display of tracking information. In the embodiment shown in FIG. 8, proximity mapping of people, objects and/or locations shows sequential contact between various entities by way of arrows in one embodiment. In the embodiment shown in FIG. 8, patient indication 92 is distinguished from caregiver indication 90 and apparatus indication 94 by the shape of the indication shown on the display 86. In other embodiments, patient indication 92 and/or caregiver indication 90 and/or apparatus indication 94 may be distinguished by color and/or shape of the indication. Although not shown in FIG. 8, duration of time within a predetermined zone and time interval between exiting and entering predetermined zones of other objects and/or people and/or locations may be displayed in other embodiments.

While several systems and methods for proximity tracking have been described herein, other uses and methods are contemplated to be within the scope of this disclosure. In one embodiment, a patient and/or caregiver has the ability to post a patient's health status and proximity information such as shown in FIGS. 2, 5, 7 and 8 on a social media web-site. In another embodiment, patients may connect with other patients with similar medical conditions. In one embodiment, the patient may acquire information on their condition, protocol, devices used and/or medication administered from the internet or another server. In one embodiment, proximity data acquired by the systems and methods described herein may be used for billing purposes (in one exemplary embodiment based on the number, type and duration of devices used and/or services rendered). In one embodiment, compliance with respect to protocol adherence (in one exemplary embodiment duration between caregiver visits, while in another the sequence of devices and/or type of consumables used) is determined based on proximity data acquired by the systems and methods described herein. As shown in FIG. 5 motion of the patient may be monitored and used to determine amount and trends in physical exertion of a patient over time. Other uses of proximity tracking system are contemplated. In one embodiment, proximity of housekeeping personnel (based on RF tags identifying the personnel in one embodiment) to RF Tags identifying locations may be used to determine when housekeeping was performed and time interval between such housekeeping events.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor(s) for carrying out the claimed subject matter. Of course, variations of those preferred embodiments will become apparent to those of ordinary skill in the art upon reading the foregoing description. The inventor(s) expect skilled artisans to employ such variations as appropriate, and the inventor(s) intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

The disclosures of any references and publications cited above are expressly incorporated by reference in their entireties to the same extent as if each were incorporated by reference individually.

1. A system for proximity tracking comprising:
a patient radio frequency tag comprising a memory; and
a caregiver radio frequency tag configured to communicate with said patient radio frequency tag when said caregiver radio frequency tag and said patient radio frequency tag are within a predetermined spatial distance from each other, said memory of said patient radio frequency tag configured to store information indicative of communication with said caregiver radio frequency tag.

2. The system of claim 1, further comprising a processing hub, said patient radio frequency tag configured to communicate with said processing huh to convey information indicative of communication with said caregiver radio frequency tag.

3. The system of claim 2, wherein said processing hub is a cellular phone.

4. The system of claim 1, wherein information indicative of communication comprises a duration of time said caregiver radio frequency tag and said patient radio frequency tag are within a predetermined spatial distance from each other.

5. The system of claim 1, further comprising a spatial contact zone between patient radio frequency tag and said caregiver radio frequency tag indicative of likelihood of physical contact between wearer of said patient radio frequency tag and wearer of said caregiver radio frequency tag.

6. The system of claim 5, further comprising a display device configured to show information indicative of communication between said patient radio frequency tag and said caregiver radio frequency tag.

7. The system of claim 1, further comprising a device radio frequency tag configured to communicate with said patient radio frequency tag when said device radio frequency tag and said patient radio frequency tag are within a predetermined spatial distance from each other.

8. The system of claim 1, wherein compliance with at least one protocol is determined based on information indicative of communication between said caregiver radio frequency tag and said patient radio frequency tag.

9. A system for tracking contagion comprising:
multiple radio frequency tags configured to identify at least one of people, location and object; and
at least one processing hub configured to track proximity between said multiple radio frequency tag, said at least one processing hub configured to identify potential contact amongst entities assigned said multiple radio frequency tags thereby identifying potential spread of contagion.

10. The system for tracking contagion of claim 9, wherein said at least one processing hub is configured to identify a duration of potential contact amongst entities assigned said multiple radio frequency tags.

11. The system of tracking contagion of claim 9, further comprising a display device configured to communicate with said processing hub, said display device configured to show potential contact amongst entities assigned said multiple radio frequency contact thereby indicating spread of contagion.

12. The system for tracking contagion of claim 9, wherein said at least one processing hub is configured to identify non-compliance with at least one protocol based on proximity between said multiple radio frequency tags.

13. The system of tracking contagion of claim 12, further comprising a display device configured to communicate with said processing hub, said display device configured to show information indicative of non-compliance with at least one protocol based on proximity between said multiple radio frequency tags.

14. The system for tracking contagion of claim 9, wherein said at least one processing hub is configured to track physical activity of a person based on proximity between said multiple radio frequency tags.

15. The system of tracking contagion of claim 14, further comprising a display device configured to communicate with said processing hub, said display device configured to show physical activity of a person based on proximity between said multiple radio frequency tags.

16. The system for tracking contagion of claim 9, wherein said at least one processing hub is configured to determine adherence to housekeeping protocol based on a duration of potential contact between multiple radio frequency tags.

17. The system of tracking contagion of claim 16, further comprising a display device configured to communicate with said processing hub, said display device configured to show adherence to housekeeping protocol based on the duration of potential contact between multiple radio frequency tags.

18. A system comprising:
means to track spread of contagion based on proximity of multiple radio frequency tags with respect to each other.

19. A system comprising:
means to determine adherence to a protocol based on proximity of multiple radio frequency tags with respect to each other.

20. A system comprising:
means to determine physical activity of a person based on proximity of multiple radio frequency tags with respect to each other.
